(19) United States
(12) Patent Application Publication
(10) Pub. No.: US 2026/0216907 A1
(43) Pub. Date: Jul. 30, 2026

(54) METHOD FOR PROVIDING A COMPENSATION SHEET FOR A PRESSING STATION AND METHOD FOR SETTING A CARDBOARD PROCESSING MACHINE

(71) Applicant: BOBST MEX SA, Mex (CH)

(72) Inventors: David GENTIL, L’Auberson (CH); Carles SAGUÉS MITJANA, Villars-sous-Yens (CH)

(73) Assignee: BOBST MEX SA, Mex (CH)

(21) Appl. No.: 19/150,321

(22) PCT Filed: Jan. 31, 2024
(86) PCT No.: PCT/EP2024/052286

§ 371 Date: Jul. 23, 2025

(30) Foreign Application Priority Data
Jan. 31, 2023 (EP) 23154115.2

(51) Int. Cl. B26F 1/44

(52) U.S. Cl. CPC B26F 1/44

(57) ABSTRACT

A method is provided for providing a compensation sheet (34) for an individual and specific pressing station unit (16) of a cardboard processing machine (10), in particular a die-cutting and/or creasing machine. The method comprises determining an unevenness of an upper platen (24) with respect to a lower platen (26) of a pressing station (16) during a pressing process, establishing at least one compensation sheet (34) with a varying thickness for compensating said unevenness, and producing said sheet (34). The sheet's shape does not depend on the processing job carried out by the machine. Furthermore, the method provides several compensation sheets (34, 34′), each sheet being optimized for a given operating pressure.

The invention refers to a method for providing a compensation sheet for a pressing station of a cardboard processing machine, in particular, a die-cutting and/or creasing machine as well as a method for setting a cardboard processing machine.

In cardboard processing machines, especially in die-cutting and creasing machines, a cardboard arranged in a feeding station is gripped and transported through a pressing station, a waste ejection station, and a blanking station.

In the pressing station, a cardboard may be cut and creasing lines may be created. A creasing line is a compression of the cardboard where the cardboard is configured to be folded to create a box. To create a cut or creasing line, the pressing station has a lower platen and an upper platen arranged above the lower platen, wherein the platens are moveable towards each other. To each platen, a tooling plate may be attached which carries knives and/or creasing rules respectively creasing counterparts corresponding to the knives and/or creasing rules.

To create an accurate cutting line, the pressure applied to the cardboard must be uniform. In particular, the distance between the plate and the knives must be very precise, in the order of a tens of micrometre.

The pressure to be applied is specific for different cardboard materials and for the shapes to be cut.

While cutting or creasing a cardboard, high pressures may act on the platens of the pressing station, such that platens may be slightly deformed, which adversely affects the quality of the cut.

Currently, when setting up a cardboard processing machine, a test cut is performed with the desired layout of knives. The test cut is inspected by an operator, and based on the result of the test cut, the operator will create a patching sheet by manually adding patches in the areas where the test cut has not been performed properly. The patches locally increase the thickness of the setup and thus compensate for the unevenness of the platens. However, this procedure is time-consuming, creates waste, and requires an experienced operator.

Document DE 39 07 826 A1 discloses a method for creating and testing a patching sheet outside of the cardboard processing machine, by using a separate impression machine to reduce downtime. The separate machine is capable of applying a variable pressure at different locations of the sheet; allowing the operator to determine the pressure to apply on each of the cutting knives to perform a clean cut, thereby compensating for the knives' imprecision. To translate the pressure into patching thickness, the method measures the deformation of the upper and lower platen at different pressures applied in a uniform manner across the platen surface. Given the required pressure for each cutting knife, the method computes the patching thickness applied on top of each knife by combining said thickness with a value from a prior calibration of the separate impression machine.

It is an object of the present invention to provide an optimized solution for compensating the unevenness of the platens of a pressing station in a cardboard processing machine in a simple manner.

This object is achieved by a method for providing a compensation sheet for a pressing station of a cardboard processing machine, in particular a die-cutting and/or creasing machine. One of the method step determines the unevenness of the upper platen with respect to the lower platen of the pressing station during a pressing process. The unevenness may be determined individually for each platen and then combined, or may be determined as a relative unevenness that measures the unevenness of one platen with respect to the other one. At least one compensation sheet with a varying thickness is established and produced for compensating the unevenness of the upper platen and/or the lower platen during the pressing process.

By unevenness of the upper platen with respect to the lower platen, we mean the unevenness of the distance between the two platens (over the whole platen surface).

The compensation sheet can be added directly to the upper platen and/or the lower platen or at another position in the setup. Due to its varying thickness, the compensation sheet locally adds thickness to the upper platen or to the lower platen and thus compensates for the relative unevenness of the platens. Thus, the compensation sheets levels the platens so that they behave like if they were perfectly flat and parallel. As a result, the compensation sheet ensures that the pressure in the pressing station is applied evenly over the whole surface of the upper platen and the lower platen.

In particular, the core idea of the invention is to guarantee that the cardboard will be cut properly for any pressure setting of the machine by ensuring a uniform pressure distribution, independently from the layout of the knives, i.e. the processing layout, used to cut and/or crease the cardboard. Thus, the compensation sheet is a sheet whose thickness compensates for the unevenness according to a compensation layout that does not depend on the processing layout. In other words, the compensation by the sheet's thickness is implemented at locations of the platen surface that are independent of the locations of the knives used to process the cardboard. Thus, the compensation layout is not related to (i.e. in general not aligned with) the cardboard processing layout as it is traditionally done in the state-of-the-art. In this way, the compensation works for any cutting or creasing layout. The compensation sheet is preferably a sheet whose thickness compensates the unevenness across all the sheet surfaces, that is across the surface that corresponds to the operational surface of the platen. Thus, in this case, not only along the layout of the cutting knives. The operational surface of the platen is the part of the platen that may carry a cutting knife. It corresponds to the complete platen in most cases, or to the platen without its borders in some other implementations.

In practice, the compensation sheet might have areas within the operational surface of the platen that are void of compensation thickness, without impairing its capability of compensating the unevenness of the platen independently of the location of the cutting knives, as long as the surface covered by the areas of thickness compensation is large enough and well-distributed enough, for example by having pillars spread across the platen operational surface, for example, uniformly or randomly distributed. Having pillars uniformly or randomly distributed over the platen operational surface is, by design, independent of the cardboard processing layout. The voids in the compensation thickness may be used for ventilation ducts for cooling purposes. They may also be used as vacuum ducts to hold the cardboard in contact with the upper platen. Nevertheless, the preferred implementation uses compensation sheets with a compensation thickness across all the platen operational surface, except for voids related to vacuum ducts if there are any.

Thanks to the compensation sheet, the need for applying additional patches to the upper platen or the lower platen is void or at least strongly reduced. However, it is still possible to add additional patches to the compensation sheet if needed.

The compensation sheet can be made of metal and thus has high stability. It may also be made of glass fibers with resin, carbon fibers with resin, paper printed with polymer inks, technical ceramic, or plastic.

According to one aspect, the unevenness of the upper platen compared to the unevenness of the lower platen is determined for at least one, but preferably several pressure settings of the pressing station. For each pressure setting, the method determines the required thickness compensation needed to compensate for said unevenness. This compensation varies depending on the location over the platen surface, resulting in a compensation sheet with a varying thickness for each pressure setting. In practice, a compensation sheet is used for a range of pressure settings around the pressure used to determine the thickness profile of the compensation sheet.

The required pressure used in the pressing station depends on the material to be cut and/or creased, and on the design of the cutting/creasing layout for a specific job. Once the pressure setting is determined (using known methods), the corresponding compensation sheet is selected and installed in the pressing station along with the tooling plate having this layout. Thanks to the compensation sheet, the cut or crease may then be performed without any additional compensation (or with at least a very reduced compensation requirement if the cut/crease does not meet the specifications).

According to one aspect, the unevenness (of the upper platen with respect to lower platen) is determined using a simulation software by computing a deformation of the upper platen and a deformation of the lower platen and comparing them. For example, the comparison may involve subtracting the two deformations and keeping the vertical component of the difference. The result of the comparison is used for establishing the thickness of the compensation sheet. The unevenness is computed for a specific operating pressure setting of the pressing station. The resulting pressure-dependent compensation is specific to a pressing station model. It depends on the materials constituting the pressing station and on its geometric layout. Thus, the resulting pressure-dependent compensation is identical for every pressing station prototype of the same model. In other words, we get model-specific compensation sheets.

According to one aspect, the thickness of the compensation sheet may be adapted to compensate for the pressing station tolerances, resulting in a prototype-specific compensation sheet. The compensation sheet may be established, for a specific operating pressure, by measuring the unevenness of the upper platen with respect to the lower platen, by analyzing one or several patching sheets used at said operating pressure, or by using a pressure-sensitive sheet. The resulting compensation sheet will be specific to each individual pressing station unit.

According to one aspect, the unevenness of the upper platen with respect to the lower platen may be measured using a measurement plate. The measurement plate may be made, for example, of a set of supports and of one or several sensors. The supports allow the pressing station to be set under pressure. The sensors are configured to measure the distance between the upper and lower platen, or, more generally, between the moving and the fixed surface of the pressing station.

According to one aspect, the method for producing a prototype-specific compensation sheet may be repeated for several operating pressures, resulting in several prototype-specific compensation sheets, each adapted for a range of operating pressures.

According to one aspect, the method for producing a prototype-specific compensation sheet may be combined with the method for producing model-specific compensation sheets. The combination allows measuring the unevenness of a specific pressing station prototype only once using a single operating pressure and computing all the other compensation sheets adapted to a different operating pressure using the simulation software. Thus, a first unevenness is determined using any of the prototype-specific methods at a first operating pressure. A second unevenness is computed using the simulation software at the same (first) operating pressure. The second unevenness is subtracted from the first unevenness resulting in a unevenness correction. This unevenness correction accounts for the construction tolerances of the pressing station at hand. Then, at least one additional unevenness is computed using the simulation software for an additional operating pressure. The unevenness correction is added to the additional unevenness to establish and produce a compensation sheet, which is then associated with the additional operating pressure. The method may be repeated for any operating pressure setting.

According to one aspect, the unevenness of the upper platen with respect to the lower platen is determined using a measurement plate several times, each time using a different operating pressure of the pressing station. Each measured unevenness may then be used to produce a compensation sheet adapted for each operating pressure.

According to one aspect, the above-mentioned unevenness correction may be used for producing a correction compensation sheet. Said correction compensation sheet is then used in addition to the model-specific compensation sheets, i.e. is superposed to the model-specific compensation sheets. In other words, the correction compensation sheet is inserted in the pressing station and stays there, while the model-specific compensation sheets are chosen according to the operating pressure.

The compensation sheet(s) may be produced by an additive manufacturing technique or by subtractive manufacturing (i.e. engraving, etching, milling, etc). For example, the compensation sheet is produced by 3D printing, or by chemical etching, or laser engraving. Thereby, the compensation sheet is produced with a particularly high thickness accuracy.

The object is further achieved by a method for setting a cardboard processing machine. The method comprises providing several compensation sheets to be used in the cardboard processing machine, in particular at least two different compensation sheets, the compensation sheets being produced according to the inventive method described above, each compensation sheet being specific for an operating pressure used in the cardboard processing machine. An operating pressure for operating the pressing station is chosen and at least one compensation sheet is selected based on the operating pressure, and the selected compensation sheet is superimposed with the upper platen or the lower platen in the cardboard processing machine.

The object is further achieved by providing a set of at least two compensation sheets to compensate the unevenness of an upper platen with respect to a lower platen of the pressing station during a pressing operation. The system is uniquely configured for a specific, individual pressing station unit. The system comprises a set of at least a first and a second compensation sheet, wherein each compensation sheet has zones with different thicknesses according to a compensation layout. The compensation layout establishes the sheet's thickness based on its position across the surface of the compensation sheet. The first sheet is designed according to a first compensation layout that compensates for the unevenness between the two platens when the platens are pressed together with a first operating pressure, while the second sheet is designed according to a second compensation layout that compensates said unevenness for a second, different, operating pressure. The compensation layouts compensate for the unevenness over at least 10% of the operational surface of the upper-, or lower platen, but preferably across most, if not the complete, operating surface. In other words, to be effective, the compensation must be present over at least part (10%) of the operating surface of the platens.

Further features and advantages of the invention can be derived from the following description and the enclosed drawings. In the drawings

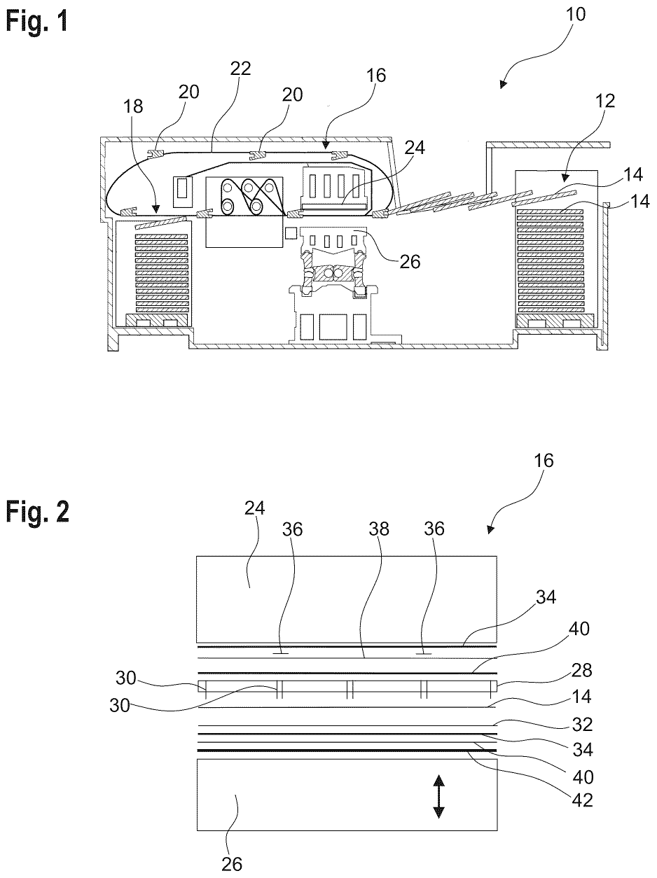

FIG. 1 shows a cardboard processing machine with a pressing station, and

FIG. 2 shows a pressing station in a schematic view.

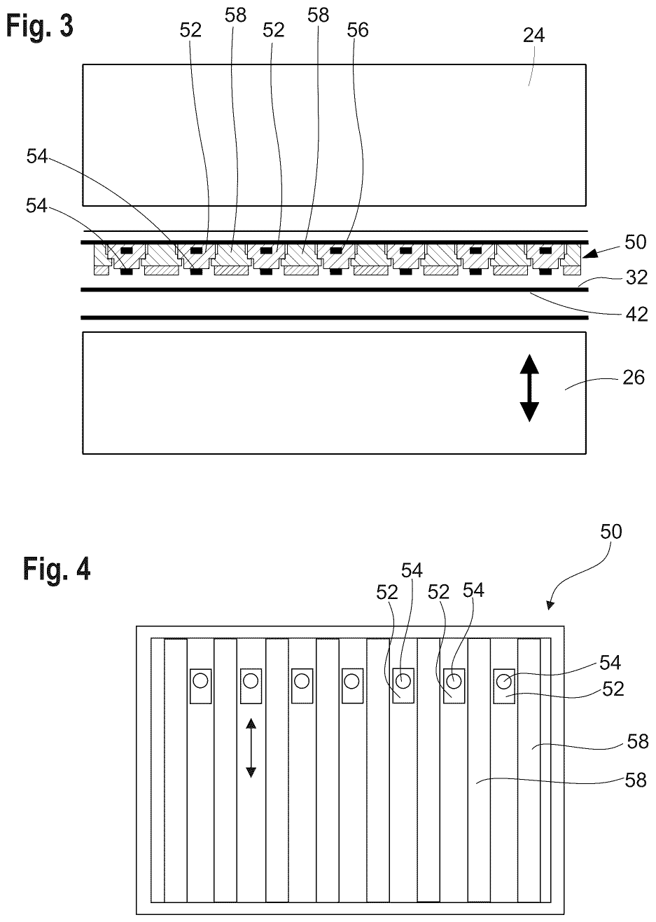

FIG. 3 shows an example of a measuring plate inserted into a pressing station

FIG. 4 shows a top view of the measuring plate of FIG. 3

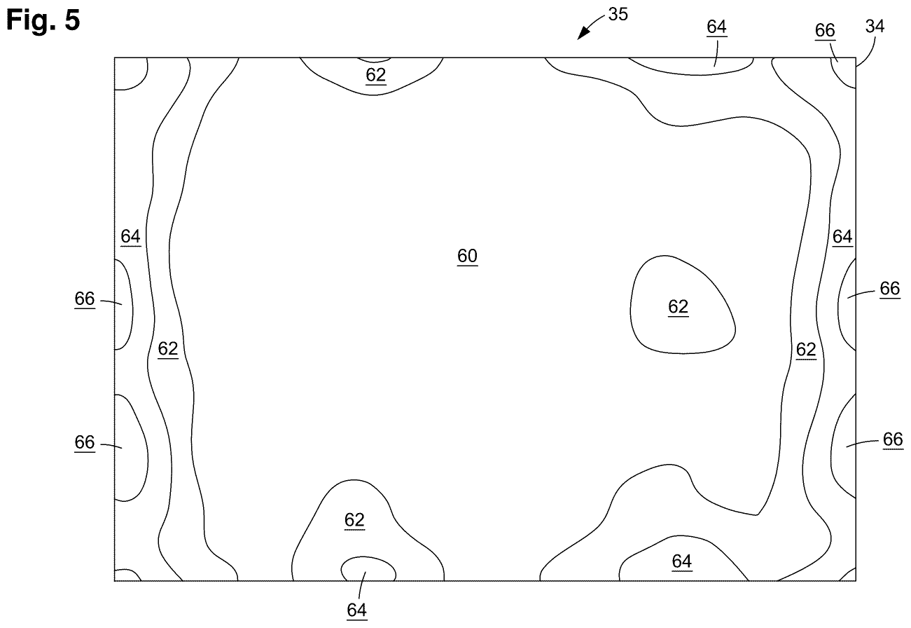

FIG. 5 shows an example of a compensation sheet with a compensation layout adapted for a first operating pressure of the pressing station unit.

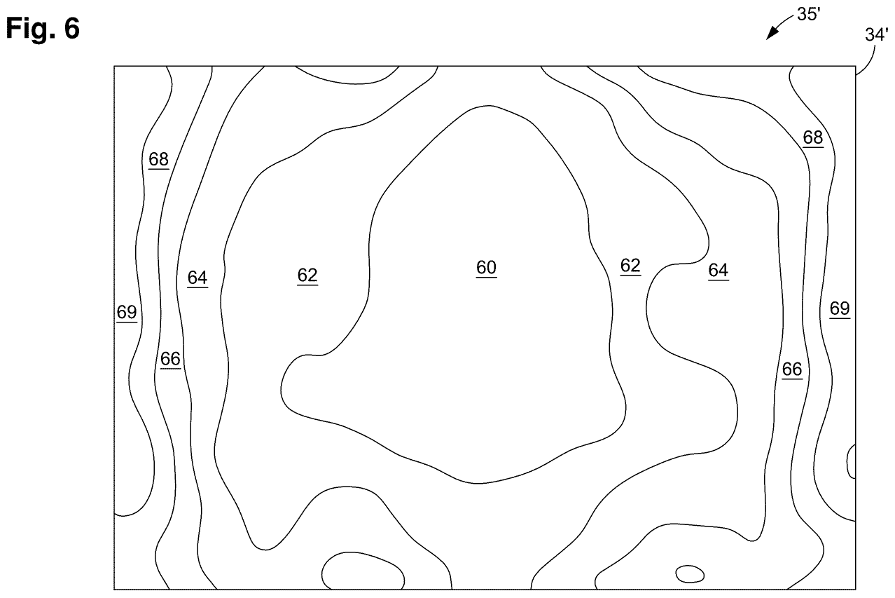

FIG. 6 shows an example of a compensation sheet using a second compensation layout adapted for a second, different, operating pressure for the same pressing station unit.

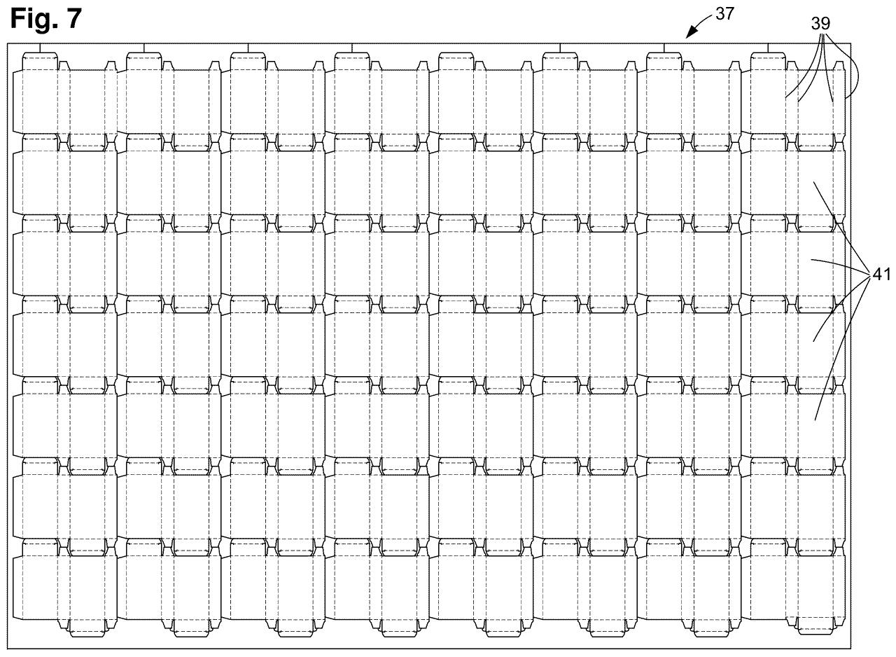

FIG. 7 shows a processing layout to cut and crease blanks out of a sheet of cardboard.

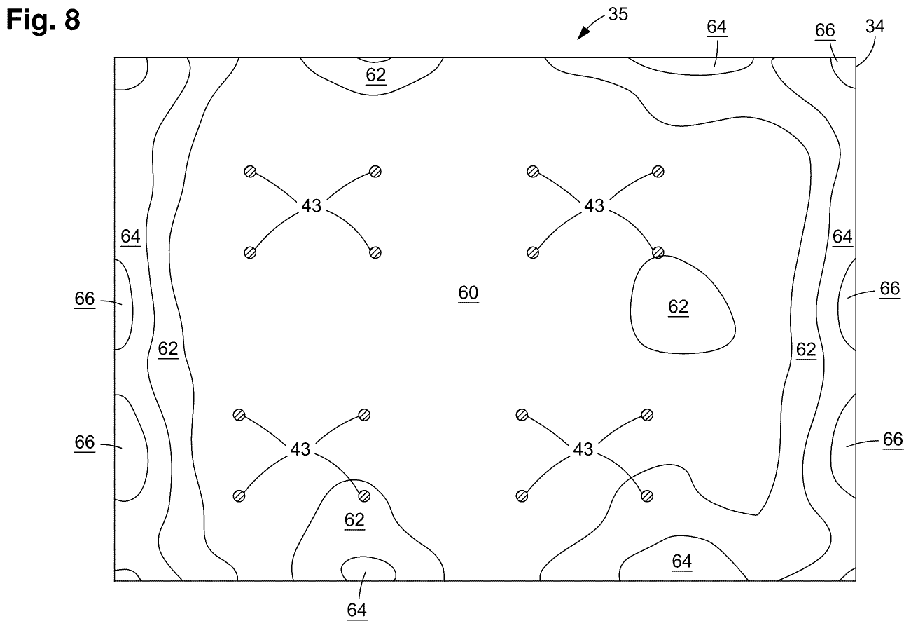

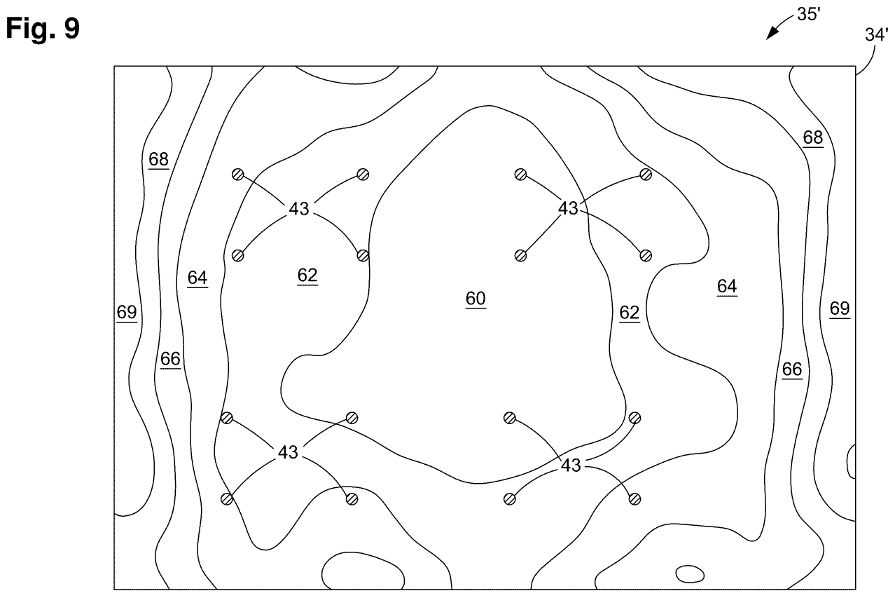

FIGS. 8 and 9 show the compensation sheets of FIGS. 5 and 6 for a pressing station that uses vacuum ducts.

FIG. 1 shows a cardboard processing machine 10, in particular, a die-cutting and/or creasing machine.

The cardboard processing machine 10 comprises a feeding station 12 in which cardboard blanks 14 to be processed are piled.

Further, the cardboard processing machine 10 comprises a pressing station 16 in which the cardboard blanks 14 are cut or creased.

In a piling station 18, the cardboard blanks 14 can be piled before they are withdrawn from cardboard processing machine 10.

The cardboard blanks 14 can be moved along a processing direction by means of gripper bars 20, which are attached to a drive chain 22.

In the following, the pressing station 16 is described in more detail.

In particular, the pressing station 16 comprises an upper platen 24 and a lower platen 26. The upper platen 24 is arranged above the lower platen 26.

The platens 24, 26 are moveable towards each other to cut or crease a cardboard blank 14 positioned between the platens 24, 26.

In the exemplary embodiment, the upper platen 24 is fixed and the lower platen 26 is moveable.

To cut the cardboard blanks 14, a tooling plate 28 (see FIG. 2) carrying knives 30 may be attached to the upper or lower platen 24, 26. The knives 30 are positioned across the platen surface and form a processing layout 37 by creating cuts or creases 39 on the cardboard, and separating the cardboard into blanks 41.

Instead of the knives 30, it is also possible that the tooling plate 28 is carrying creasing rules for creasing the cardboard blanks 14.

To the other platen 24, 26, an optional tooling plate 32 with slots or grooves corresponding to the knives 30 and/or creasing rules is attached.

The tooling plates 28, 32 are exchangeable since different tooling plates 28, 32 are necessary for different production jobs.

Also, the pressure distribution in the pressing station 16 upon actuation of the pressing station may vary depending on the cardboard to be processed as well as depending on the cutting design.

Due to the high pressures acting on the upper platen 24 and the lower platen 26 during a cutting process, the platens 24, 26 may slightly deform when the pressing station 16 is actuated.

The unevenness is for one part due to the size of the upper platen 24 and the lower platen 26, which is in the range of 1 m² to 2 m².

However, to ensure an accurate cut, the accuracy of distance between the platens 24, 26 during a pressing process needs to be in the range of a few tens of micrometers.

Thus, to ensure an accurate cut, the unevenness of the upper platen 24 with respect to the lower platen 26 must be compensated.

For this purpose, at least one compensation sheet 34 is provided. The compensation sheet may be assigned to the upper platen 24 or to the lower platen 26, with an equivalent effect on the cut, as depicted in FIG. 2. In most embodiments, there is only a single compensation sheet 34 in one of the positions depicted in FIG. 2, and no sheet in the other depicted position.

In FIG. 2, the compensation sheets 34 appear as a flat plate for simplicity and because the thickness variation is tiny compared to the size of the sheet; however, to compensate for the unevenness of the platens 24, 26, the compensation sheets 34 have a varying thickness, as shown in FIG. 5, 6, 8, or 9

In the embodiment, the compensation sheet 34 is assigned to the upper platen 24 and is positioned between the platen and the tooling plate 28.

The compensation sheets 34 have a high stability and may, for example made, be made of steel.

The compensation sheets 34 are, for example, produced by an additive manufacturing technique or by engraving.

The compensation sheets 34 compensate for the platen unevenness with a compensation layout 35 that covers the complete operational surface of the platen 24,26, i.e. the part of the surface that can be used for processing cardboard, which result in a set of blanks 41 (in most implementations, this corresponds to the complete platen surface). Ideally, the thickness is defined in every location of the sheet across the complete platen operational surface. In practice, the compensation would also work if some of the surface is left out, as long as said surface is surrounded by compensating parts. In other words, the compensation sheet could be made of “pillars” of thickness spread across the platen surface. The pillars should cover at least 10% of the operational surface of platen and be spread across said surface (i.e. not concentrated only on one side). Preferably, it should cover from 25% to 100% of said operational surface. FIG. 5 shows an example where the thickness is defined in every location across the sheet surface (i.e., the compensating thickness covers 100% of the operational surface).

In an exemplary embodiment, the compensation sheets 34 are designed based on a simulation, in particular using a finite element method.

More precisely, a method for providing a compensation sheet 34 may comprise simulating an unevenness of the upper platen 24 and a lower platen 26 of the pressing station 16 during a pressing process by means of simulation software. The simulation software takes the physical property of the platen into account, as well as the location of the pressure points, i.e. the points where the creasing machine presses on the platen, or the point where the platen is held. The simulation is performed at a given operating pressure. The operating pressure is converted into a pressure per unit surface given the total (usable) surface of the platens 24,26. The simulation assumes that said pressure per unit surface is applied uniformly on every point of the platen 24,26, and computes a deformation for each platen 24,26. By subtracting said deformation, or equivalently by computing the variation of distance between the two platens deformed according to the computation, and retaining the vertical component of the deformation, we obtain a value at each location of the platen surface. Said value corresponds to the thickness of the compensation sheet 34 at that location.

Based on the result of the simulation, a compensation sheet 34 with a varying thickness for compensating the combined deformation of the upper platen 24 and the lower platen 26 during a pressing process is computed and then produced.

In particular, the compensation sheet 34 has a basic thickness that is required for sufficient stability of the compensation sheet 34. The varying thickness required for compensating the unevenness of the upper platen 24 with respect to the lower platen 26 may be added up to the basic thickness by additive manufacturing. Conversely, the varying thickness required for compensating the unevenness of the upper platen 24 with respect to the lower platen 26 may be obtained by removing material from the basic thickness by engraving, for example by laser engraving.

The relative unevenness of the upper platen 24 and the lower platen 26 is computed as a function of pressure. Preferably several sheets are produced for each cardboard processing machine prototype, each sheet 34, 34′ being associated with a specific operating pressure.

When computing the thickness of the compensation sheets 34, 34′, machine tolerances of a cardboard processing machine 10 can also be considered, such that the compensation sheets 34, 34′ are computed to compensate machine tolerances of the cardboard processing machine 10 as well as the deformation induced by pressure.

In an exemplary embodiment shown in FIG. 3, the unevenness of the upper platen with respect to the lower platen is measured using a measurement plate 50. The measurement plate comprises a structure 58 designed to support pressure and at least one sensor 52 configured to measure the distance between the two platens 24,26. The structure 58 designed to support pressure may be constructed using similar material to a standard setting tool, but without the cutting knives, as shown in FIG. 3. The sensor may be a sensor couple 54,56, each measuring the distance from the sensor to one of the platens 24,26. The measurement plate 50 is introduced in the pressing unit 16 and pressed by choosing an operating pressure. By displacing the sensor in-between the structure 58, we get a sampling of the distance between the two platens 24,26 over the whole platen surface, i.e. we get the unevenness of the upper platen 24 with respect to the lower platen 26 at said operating pressure. The measurement may be repeated for several operating pressure settings. Preferably, we perform only a measurement at a single operating pressure. Instead of using a displaceable sensor(s) 52, we may also put a set of fixed sensors. The sensor(s) may be a laser triangulation sensor, an inductive sensor, a capacitive sensor, a lidar, or a mechanical probe.

In another exemplary embodiment, the unevenness of the upper platen with respect to the lower platen is estimated by collecting a set of patching sheets 38 consisting of at least one sheet but preferably consisting of several sheets. These sheets 38 are created by trial and error when using the pressing station 16 of a dye-cutting machine 10 in a traditional way. The set of sheets 38 is selected such that all the sheets were used using (approximately) the same operating pressure. A typical patching sheet comprises the drawing of the layout of the cutting knives. The patches have a color code, each color corresponds to an added thickness. Thus, at each point of the layout, we get, either no thickness correction if there is no patch or a correction with a thickness corresponding to the color of the patch. Outside of the layout, there is no information about the correction to be applied. By averaging the sheets of the set, and interpolating where there is missing information (thickness), we get a thickness layout for producing a compensation sheet 34.

In another exemplary embodiment, the unevenness of the upper platen 24 with respect to the lower platen 26 is measured using a pressure sheet. The pressure sheet is set under pressure in the pressing station using a cutting or creasing tool with many contact points. The pressure sheet typically delivers the pressure for every contact point using a color code. From there, we compute the correction of pressure to reach a constant pressure at every constant point and convert the correction of pressure into an added thickness. To do so, we either proceed using an empirical formula built by trial and error, or by using the simulation software mentioned earlier in the description if the pressure reading is well calibrated.

In another exemplary embodiment, the unevenness of the upper platen 24 with respect to the lower platen 26 is determined by using a plate comprising a multitude of pillars. When putting the sheet under pressure, the pillars deform and can be measured by an offline measurement device or may be reproduced by a molding operation. The embodiment may be used at several operating pressures (but each prototype may only be used once since the pillars get permanently deformed). The pillars may be made of soft metal, for example, made of copper, aluminum, or lead.

In a preferred embodiment, a method for providing a compensation sheet 34 comprises simulating the deformation of the upper platen 24 and the deformation of the lower platen 26 of the pressing station 16 during a pressing process by using simulation software for several operating pressures and combining the result with a method for providing a compensation sheet 34 to compensate the machine tolerances. To do so, a first unevenness is determined using any of the above-mentioned methods for compensating the machine tolerances. A second unevenness (i.e. a deformation in this case) is computed using the simulation software for the same (first) operating pressure. Then, the second unevenness is subtracted from the first unevenness resulting in a corrective unevenness. Please note that the second unevenness may be null if the chosen (first) operating pressure is close to zero. To compute the compensation sheets 34, 34′, the method uses the simulation software to compute the unevenness of the upper platen 24 with respect to a lower platen 26 as described before, for several operating pressures. Each unevenness is then corrected by adding the corrective unevenness to obtain a thickness layout 35,35′ (60,62,64,66,68,69), which we call the compensation layout, and produce a compensation sheet 34,34′ for each said operating pressure.

As an alternative, an individual compensation sheet 34,34′ can be produced using the corrective unevenness, while producing the other sheets using the simulation software alone. In this case, we use two sheets in the pressing station 16: the individual compensation sheet, which compensates for the pressing station tolerances superposed to one of the pressure-dependent compensation sheets 34,34′, which compensates for the pressure-dependent unevenness of the pressing station model. The latter is changed if the operating pressure changes, while the former stays in the pressing station.

For setting a cardboard processing machine, several compensation sheets 34,34′ to be used in the cardboard processing machine 10 are provided, wherein the compensation sheets 34,34′ are produced according to the method described above.

In a preferred embodiment, each of the several compensation sheets 34,34′ is configured for a range of pressures around an operating pressure. For example, we may have a first compensation sheet 34 for an operating pressure of 400 kilo Newton (kN) adapted for a pressure ranging from of 0 to 1 mega Newton (MN), a second sheet 34′ for an operating pressure of 1.6 MN tons adapted for a pressure ranging from 1 NM to the maximum pressure allowed by the pressing station. Then, depending on the pressure required by the converting job, the appropriate sheet is used in the processing machine. For example, if a processing job requires a pressure of 800 kN, the above-mentioned first sheet 34 is introduced in the platen press for the job. Please note that we may provide more than 2 sheets per pressing station units if a finer sampling of the operating pressure is needed.

In a preferred embodiment, the compensation sheet 34,34′ is made of fiberglass with resin and produced by engraving, for example using laser engraving.

The compensation sheet 34,34′ has a varying thickness, as depicted in FIGS. 4 and 5. Each zone 60,62,64,66,68, (69) has a different thickness. The thickness of a zone differs from the thickness of the other zones by steps of, for example, 20, 35, or 50 microns.

An operating pressure for operating the pressing station 16 and a tooling plate 28, 32 for operating the pressing station 16 is chosen.

After choosing the operating pressure, a compensation sheet 34 is chosen based on the operating pressure. If there is no compensation sheet 34 available for a desired operating pressure, one may choose the compensation sheet 34 made for the closest operating pressure.

The selected compensation sheet 34 is superimposed with the upper platen 24 or the lower platen 26 in the cardboard processing machine 10.

If the cut is still not accurate enough after adding the compensation sheet 34, it is still possible to add patches 36 to the pressing station, as it is depicted in FIG. 2.

In the depicted embodiment, the patches 36 are assigned to the upper platen 24, however, patches 36 can also be assigned to the lower platen 26.

For easy handling of the patches 36, the patches may be applied to a patching sheet 38 which is superimposed with the compensation sheet 34.

Optionally, separate plates 40 are provided to support the tooling plates 28, 32 and/or the compensation sheet 34.

Furthermore, an optional support plate 42 is attached to the lower platen 26.

In an embodiment, a set of at least two compensation sheets 34,34′ shown in FIGS. 5 and 6, are provided to compensate the unevenness of the upper platen 24 with respect to the lower platen 26 of the pressing station unit 16 during a pressing operation. The system is uniquely configured for a specific, individual pressing station unit 16. The system comprises a set of at least a first compensation sheet 34 and a second compensation sheet 34′, wherein each compensation sheet has zones 60, 62, 64, 66, 68 (69) with different thicknesses, each according to a compensation layout 35,35′, respectively. The compensation layout establishes the sheet's thickness based on its position across the surface of the compensation sheet. The first sheet 34 is designed according to a first compensation layout 35 that compensates for the unevenness between the two platens 24,26 when the platens are pressed together with a first operating pressure, while the second sheet 34′ is designed according to a second compensation layout 35′ that compensates said unevenness for a second, different, operating pressure. In the example of FIGS. 5 and 6, the compensation layouts 35,35′ compensate for the unevenness across the complete operational surface of the upper-, or lower platen.

In an embodiment, a set of compensation sheets depicted in FIGS. 8 and 9, comprise holes 43 that allow the pressing station to apply vacuum to hold the sheet on the platen prior to the pressing operation, or to make sure that the cardboard sticks to the appropriate platen after the pressing operation. The holes are positioned at specific location in the compensation layout which correspond to the vacuum duct in the platen, thus these location are the same in sheet 34 and sheet 34′.

The set of at least two compensation sheets 34, 34′ can be used to improve significantly the productivity of a legacy machine 10 that is already installed and running in the industry. It removes the need for “patching”, i.e. it removes the need for sticking patching bands through a lengthy trial-and-error process that must be performed manually for each distinct processing job on these machines.

1. A method for providing a compensation sheet for a pressing station of a cardboard processing machine for processing cardboard according to a processing layout, which defines the shape of a blank-processed by the cardboard processing machine, in particular a die-cutting and/or creasing machine, the method comprising:
determining an unevenness of an upper platen with respect to a lower platen of the pressing station during a pressing process,
establishing at least one compensation sheet with a varying thickness for compensating the unevenness of the upper platen with respect to the lower platen during the pressing process, and
producing at least one respective compensation sheet,
wherein the thickness of the compensation sheet compensates for said unevenness according to a compensation layout that establishes the sheet's thickness based on its position across the surface of the compensation sheet, and
wherein said compensation layout is independent of the cardboard processing layout such that the compensation layout does not depend on the shape of the blank processed by the processing machine.

2. The method according to claim 1, wherein the compensation layout compensates for said unevenness over at least 10% of the operational surface of the upper platen.

3. The method according to claim 1, wherein the compensation layout compensates for said unevenness over most of the operational surface of the upper platen.

4. The method according to claim 1, wherein the unevenness of the upper platen with respect to the lower platen is determined as a function of pressure.

5. The method according to claim 4, wherein the method is applied for at least two operating pressure settings of the pressing station for producing at least two compensation sheets according to two different compensation layouts; each compensation sheet being adapted for a range of operating pressure around said two operating pressure settings.

6. The method according to claim 1, wherein the unevenness is determined by measuring the vertical component of the deformation of the upper platen with respect to the lower platen and wherein said vertical component corresponds to the thickness variation across the compensation layout of the compensation sheet.

7. The method according to claim 1, wherein the unevenness is determined using a simulation software by computing a deformation of the upper platen and a deformation of the lower platen.

8. The method according to claim 6, wherein the vertical component of the deformation of the upper platen is subtracted from the vertical component of the deformation of the lower platen and corresponds to the thickness variation of the compensation sheet.

9. The method according to claim 1, wherein the thickness of the compensation sheet is adapted to compensate for the pressing station tolerances.

10. The method according to claim 9, wherein the unevenness of the upper platen with respect to the lower platen is measured using a measurement plate.

11. The method according to claim 10, wherein the measurement plate comprises a structure designed to support pressure and at least one sensor configured to measure the distance between the two platens.

12. The method according to claim 9, wherein the unevenness of the upper platen with respect to the lower platen is measured using a plate comprising a multitude of pillars, which undergo plastic deformation during the pressing process.

13. The method according to claim 9, wherein the unevenness of the upper platen with respect to the lower platen is determined by using a pressure-sensitive sheet and by analyzing said sheet after the pressing process.

14. The method according to claim 9, wherein the unevenness of the upper platen with respect to the lower platen is determined by analyzing at least one patching sheet created manually for a specific operating pressure of the pressing station.

15. The method according to claim 7, the method further comprising:
determining a first unevenness at a first operating pressure of the pressing station,
computing a second unevenness using the simulation software for the first operating pressure,
subtracting the second unevenness from the first unevenness resulting in an unevenness correction, and
computing at least one additional unevenness using the simulation software for an additional operating pressure, wherein the unevenness correction is added to the additional unevenness to establish and produce a compensation sheet associated with the additional operating pressure.

16. The method according to claim 1, wherein the compensation sheet is produced by an additive manufacturing technique or by a subtractive manufacturing technique.

17. The method according to claim 1, wherein the compensation sheet is made of fiberglass with resin and produced by engraving.

18. A method for setting up a cardboard processing machine, the method comprising:
providing several compensation sheets to be used in the cardboard processing machine, each compensation sheet being specific for an operating pressure range used in a pressing station of the cardboard processing machine,
choosing an operating pressure for operating the pressing station,
selecting a compensation sheet based on the operating pressure, and
superimposing the selected compensation sheet with an upper platen or a lower platen in the pressing station,
wherein the compensation sheets are uniquely configured for a specific, individual cardboard processing machine.

19. The method according to claim 18, wherein the compensation sheets are produced according to a method including:
determining an unevenness of an upper platen with respect to a lower platen of a pressing station during a pressing process,
establishing at least one compensation sheet with a varying thickness for compensating the unevenness of the upper platen with respect to the lower platen during the pressing process, and
producing at least one respective compensation sheet,
wherein the thickness of the compensation sheet compensates for said unevenness according to a compensation layout that establishes the sheet's thickness based on its position across the surface of the compensation sheet, and
wherein said compensation layout is independent of the cardboard processing layout such that the compensation layout does not depend on the shape of a blank processed by the processing machine.

20. A system designed to compensate an unevenness of an upper platen with respect to a lower platen of a pressing station during a pressing process, the system being uniquely configured for a specific, individual pressing station unit, the system comprising:
a set of at least a first and a second compensation sheet, wherein each compensation sheet has zones with different thicknesses according to a compensation layout that establishes the sheet's thickness based on its position across the surface of the compensation sheet,
wherein the first sheet is designed according to a first compensation layout that compensates for the unevenness of the distance between the upper platen and the lower platen of the unit when the platens are pressed together with a first operating pressure,
wherein the second sheet is designed according to a second compensation layout that compensates for the unevenness of the distance between the upper platen and the lower platen of the unit when the platens are pressed together with a second operating pressure that differs from the first operating pressure, and
wherein the first and second compensations layouts compensate for the unevenness over at least 10% of the operational surface of the upper platen; meaning that the set of locations within the sheet's surface that have a compensating thickness cover at least 10% or the operational surface of the upper platen.

21. The system according to claim 20, wherein said layouts compensate for said unevenness over most of the operational surface of the upper platen.

22. The system according to claim 20, wherein the compensation sheet's layouts comprise holes at specific locations for implementing vacuum ducts, the locations of said holes being identical for each compensation sheet.

23. The system according to claim 20, wherein the compensation sheets are used to implement a method including:
providing several compensation sheets to be used in a cardboard processing machine, each compensation sheet being specific for an operating pressure range used in a pressing station of the cardboard processing machine,
choosing an operating pressure for operating the pressing station,
selecting a compensation sheet based on the operating pressure, and
superimposing the selected compensation sheet with the upper platen or the lower platen in the pressing station,
wherein the compensation sheets are uniquely configured for a specific, individual cardboard processing machine.

24. The system according to claim 20, wherein the compensation sheets are produced according to a method including:
determining an unevenness of an upper platen with respect to a lower platen of a pressing station during a pressing process,
establishing at least one compensation sheet with a varying thickness for compensating the unevenness of the upper platen with respect to the lower platen during the pressing process, and
producing at least one respective compensation sheet,
wherein the thickness of the compensation sheet compensates for said unevenness according to a compensation layout that establishes the sheet's thickness based on its position across the surface of the compensation sheet, and
wherein said compensation layout is independent of the cardboard processing layout such that the compensation layout does not depend on the shape of a blank processed by the processing machine.
